(19) United States
(12) Patent Application Publication
(10) Pub. No.: US 2013/0013846 A1
(43) Pub. Date: Jan. 10, 2013

(54) METHOD FOR STORING DATA AND ELECTRONIC APPARATUS USING THE SAME

(75) Inventor: Chieh-Chun Lo, Hsinchu City (TW)

(73) Assignee: ALTEK CORPORATION, Hsinchu City (TW)

(21) Appl. No.: 13/195,041

(22) Filed: Aug. 1, 2011

(30) Foreign Application Priority Data
Jul. 6, 2011 (TW) 100123898

(51) Int. Cl. G06F 12/02

(52) U.S. Cl. 711/102; 711/E12.008

(57) ABSTRACT

A method for storing data and an electronic apparatus using the same are provided. Only data is written to a memory card when the electronic apparatus wants to store the data to the memory card. And file information and location information corresponding to the data stored in the memory card are recorded into a buffer block of the electronic apparatus. After a file closing action is executed, the file information and the location information recorded in the buffer block are written to the memory card.

### CROSS-REFERENCE TO RELATED APPLICATION

This application claims the priority benefit of Taiwan application serial no. 100123898, filed Jul. 6, 2011. The entirety of the above-mentioned patent application is hereby incorporated by reference herein and made a part of this specification.

### BACKGROUND OF THE INVENTION

1. Field of the Invention

The invention relates to a data accessing mechanism. Particularly, the invention relates to a method for storing data and an electronic apparatus using the same.

2. Description of Related Art

Along with progress of digital technology, conventional cameras that use films to record images have been gradually replaced by digital cameras that use digital media such as memory cards, etc. to record images. Today, a size of the digital camera becomes smaller to facilitate a user carrying around. On the other hand, a capacity of the memory card used by the digital camera is expanded to record more images, so that the user can completely record events of each moment in various occasions.

Generally, when the memory is formatted, it is divided into a master boot block, a file allocation table (FAT) block, a directory table block and a data block. The FAT block is used for storing space information of a FAT file system. Once a directory entry is written into the directory table block, files can be seen from the memory card. Once the FAT information is written into the FAT, available space of the memory card is reduced.

Generally, the digital camera is powered by a battery, and if the power cannot be supplied during a period when the file is written into the memory card, the memory card may store an incomplete file. Since a part of the FAT information has been written, the available space of the memory card is reduced.

### SUMMARY OF THE INVENTION

The invention is directed to an electronic apparatus, in which a buffer block of a suitable size is allocated in an inbuilt storage unit for temporarily storing file information and location information corresponding to data stored in a memory card during a process of writing the data to the memory card.

The invention is directed to a method for storing data, by which a problem of storing incomplete files in a memory card in cases that an electronic apparatus is suddenly power-off is avoided.

The invention provides an electronic apparatus including a memory card slot, a memory card, a storage unit and a processing unit. The memory card is inserted into the memory card slot to store data. The storage unit includes a buffer block for temporarily storing location information corresponding to the data stored in the memory card. The processing unit is coupled to the memory card slot and the storage unit. When the processing unit is about to store the data to the memory card, the processing unit records file information to the buffer block. During a period of writing data, the processing unit records the location information corresponding to the data stored in the memory card to the buffer block. Moreover, after a file closing operation is performed, the processing unit writes the file information and the location information recorded in the buffer block to the memory card.

In an embodiment of the invention, the memory card includes a data block and a file allocation table (FAT) block. The data block is used for storing the data, the FAT block is used for storing the location information (for example, FAT information), and a directory table block is used for storing the file information (for example, directory entry information).

In an embodiment of the invention, the buffer block includes a location information buffer and a file information buffer. The location information buffer is used for temporarily storing the location information, and the file information buffer is used for temporarily storing the file information.

In an embodiment of the invention, the electronic apparatus further includes a photosensing device coupled to the processing unit for capturing the data.

The invention provides a method for storing data, which is adapted to an electronic apparatus, where a memory card slot of the electronic apparatus is inserted with a memory card. In the method, when data is to be stored in the memory card, file information related to the data is recorded into a buffer block of the electronic apparatus (for example, the buffer block is located in a storage unit of the electronic apparatus). Moreover, during a period of writing the data to the memory card, location information corresponding to the data stored in the memory card is recorded to the buffer block of the electronic apparatus. After a file closing operation is performed, the file information and the location information recorded in the buffer block are written to the memory card.

In an embodiment of the invention, the location information is FAT information, and the file information is directory entry information. Moreover, the buffer block further includes a location information buffer and a file information buffer for recording the file information of the data into the file information buffer and recording the location information into the location information buffer.

In an embodiment of the invention, when the file closing operation is performed, the file information is read from the file information buffer, and is stored to the memory card. Moreover, the location information is read from the location information buffer, and is stored to the memory card.

According to the above descriptions, the file information and the location information corresponding to the data stored in the memory card are written into the memory only when the file closing operation is performed. In this way, if the electronic apparatus is suddenly power-off before the file closing operation is performed, since the file information of the incomplete file is not written into the memory card, the incomplete file cannot be seen in the memory card. Moreover, since the location information is still not written into the memory card, the available space of the memory card is not reduced.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an electronic apparatus according to a first embodiment of the invention.

FIG. 2 is a flowchart illustrating a method for storing data according to the first embodiment of the invention.

FIG. 3 is a block diagram of an electronic device according to a second embodiment of the invention.

FIG. 4 is a schematic diagram illustrating configurations of a memory card and a storage unit during a data writing process according to a second embodiment of the invention.

FIG. 5 is a schematic diagram illustrating a configuration of a memory card after a file closing operation is performed according to the second embodiment of the invention.

### DETAILED DESCRIPTION OF DISCLOSED EMBODIMENTS

To fully convey the spirit of the invention, embodiments are provided below for descriptions.

### First Embodiment

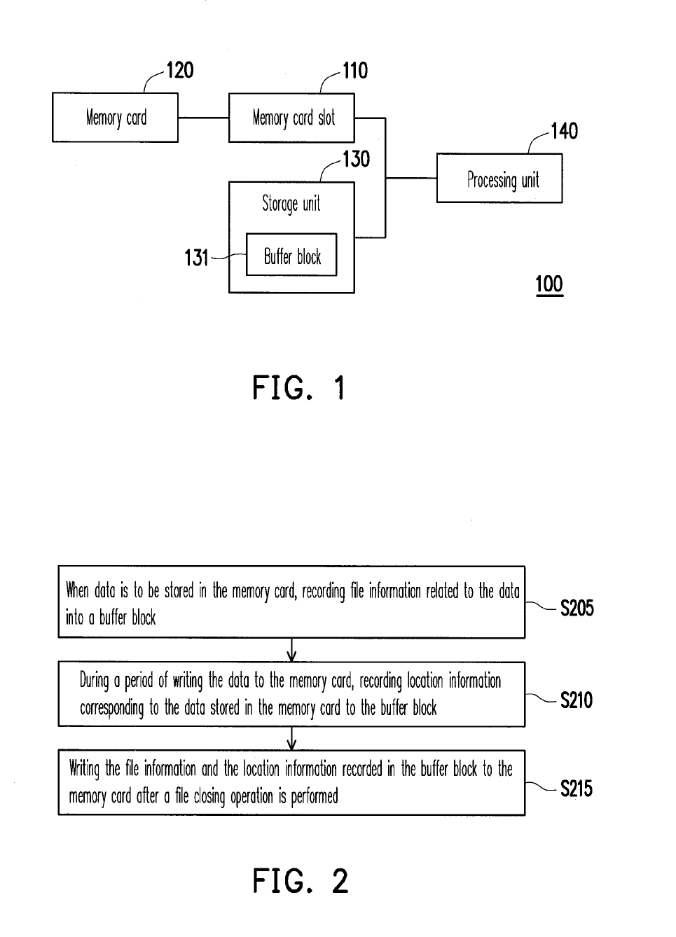

FIG. 1 is a block diagram of an electronic apparatus according to the first embodiment of the invention. Referring to FIG. 1, the electronic apparatus 100 includes a memory card slot 110, a memory card 120, a storage unit 130 and a processing unit 140. The processing unit 140 is coupled to the memory card slot 110 and the storage unit 130.

In the present embodiment, the memory card slot 110 is configured with the memory card 120, i.e. the memory card 120 is inserted into the memory card slot 110, and the memory card 120 can be disassembled from the memory card slot 110. Here, the memory card 120 is, for example, a secure digital card. In other embodiments, the memory card 120 can also be a multimedia card, a secure digital input/output card or other types of memory card.

The storage unit 130 includes a buffer block 131 for temporarily storing file information and location information of the stored data. The file information includes a file name, a file size and an initial location of the data stored in the memory card 120.

The location information records a location of the data stored in the memory card 120. Here, the storage unit 130 is, for example, a random access memory (RAM). Generally, when the data is written into the memory card 120, the file information and the location information are simultaneously written into the memory card 120, so that when the memory card 120 is accessed, the location of the data is found according to the file information and the location information. Here, the location information is, for example, file allocation table (FAT) information, and the file information is, for example, directory entry information.

The processing unit 140 is used for processing data accessing operations. When the processing unit 140 is about to store data to the memory card 120, the processing unit 140 records the file information to the buffer block 131. Moreover, during a period of writing the data to the memory card 120, the processing unit 140 records the location information corresponding to the data stored in the memory card 120 to the buffer block 131. When a file closing operation is performed, the file information and the location information recorded in the buffer block 131 are written to the memory card 120.

A method for storing data is further described below with reference of the electronic apparatus 100.

FIG. 2 is a flowchart illustrating a method for storing data according to the first embodiment of the invention. Referring to FIG. 1 and FIG. 2, in step S205, when data is to be stored in the memory card 120, file information related to the data is recorded into the buffer block 131.

Then, in step S210, during a period of writing the data to the memory card 120, location information corresponding to the data stored in the memory card 120 is recorded into the buffer block 131. Here, in order to avoid leaving incomplete data in the memory card 120 due to power-off during the data writing process, before the data is completely written into the memory card 120, the file information and the location information are first stored in the buffer block 131 instead of being stored in the memory card 120.

After the data is completely written into the memory card 120, the processing unit 140 executes a file closing operation. When the file closing operation is executed, in step S220, the processing unit 140 writes the file information and the location information recorded in the buffer block 131 to the memory card 120. In this way, the data that is not completely written does not occupy a space of the memory card 120, and only the file with the completely written data occupies the space of the memory card 120.

### Second Embodiment

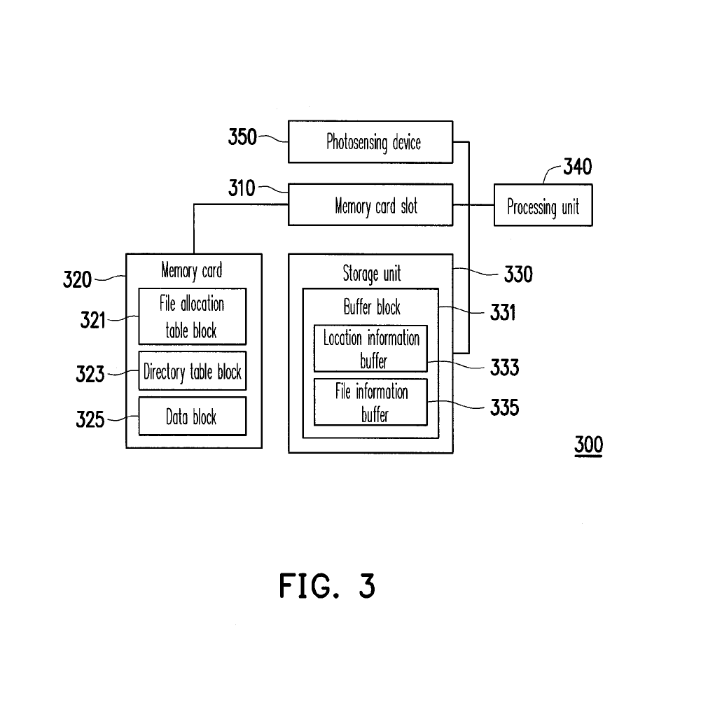

FIG. 3 is a block diagram of an electronic device according to a second embodiment of the invention. Referring to FIG. 3, the electronic device 300 is an image processing device, which includes a memory card slot 310, a memory card 320, a storage unit 330, a processing unit 340 and a photosensing device 350. The processing unit 340 is coupled to the memory card slot 310, the storage unit 330 and the photosensing device 350. The memory card 320 is inserted in the memory card slot 310, and the memory card 320 can be disassembled from the memory card slot 310. Here, the memory card 320 is, for example, a secure digital card, and the storage unit 330 is, for example, a random access memory.

The memory card 320 includes a file allocation able (FAT) block 321, a directory table block 323 and a data block 325. The data block 325 is used for storing data, and a data storage unit on the memory card 320 is referred to as a cluster. The directory table block 323 is used for storing file information. The file information records a file name, attribute, time, date, a first cluster stored in the data block 321, and a file size, etc. The file information is, for example, directory entry information. The FAT block 321 is used for storing location information, which records available storage location information of the memory card 320 and location information corresponding to the data stored in the memory card 320. The location information is, for example, FAT information.

In the storage unit 330, a buffer block 331 includes a location information buffer 333 and a file information buffer 335. The location information buffer 333 is used for temporarily storing the FAT information, and the file information buffer 335 is used for temporarily storing the directory entry information.

When the processing unit 340 detects that the photosensing device 350 captures data and is about to store the data into the memory card 320, the processing unit 340 continually writes data into the data block 325 of the memory card 320 as long as the data is kept being received.

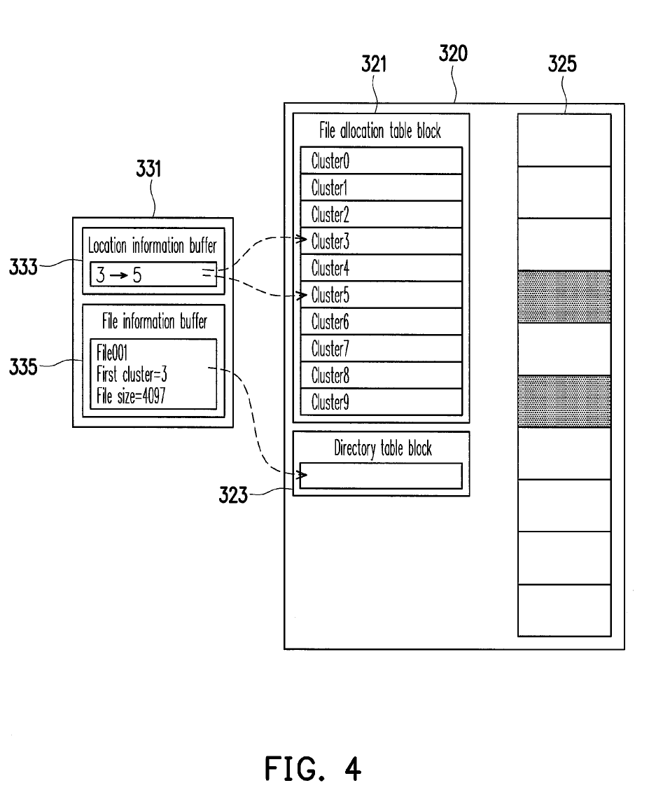

Another embodiment is provided below to describe configurations of the memory card and the storage unit during a data writing process. FIG. 4 is a schematic diagram illustrating configurations of the memory card and the storage unit during a data writing process according to a second embodiment of the invention. For simplicity's sake, in the present embodiment, only 10 clusters of the data block 325 are illustrated, though the invention is not limited thereto. Each record (one of clusters 0-9) in the FAT block 321 represents a usage state of one cluster.

Referring to FIG. 4, when the data is written into the data block 325, the processing unit 340 records a file name (for example, “File001”) of a file corresponding to such batch of data into the file information buffer 335, and stores a location of a first cluster (for example, the first cluster is the cluster 3) where the data is stored. In this way, in the file information buffer 335, “File001” is the file name of the data stored in the data block 325, “the first cluster=3” represents that the data “File001” stored in the data block 325 is started from the cluster 3, and “file size=4097” represents that a file size of the data “File001” is 4097K. Assuming a cluster size is 4096K, the data “File001” then requires two clusters for storage.

The location information buffer 333 records that the data “File001” stored in the data block 325 is started from the cluster 3, and after the cluster 3 is stored full, the remained data is stored in the cluster 5.

Now, since the directory table block 323 in the memory card 320 is still not written with the file information, so that the data “File001” cannot be seen in the memory card 320. Moreover, the FAT block 321 is still not written with the FAT information, so that the available space of the memory card 320 is not reduced. Although the data part is already written into the data block 325 of the memory card 320, before the location information and the file information are written into the memory card 320, the written data is meaningless (cannot be accessed, and existence thereof cannot be known). Therefore, if the power is off during the data writing process, the memory card 320 is equivalent to a situation that none data is written thereon.

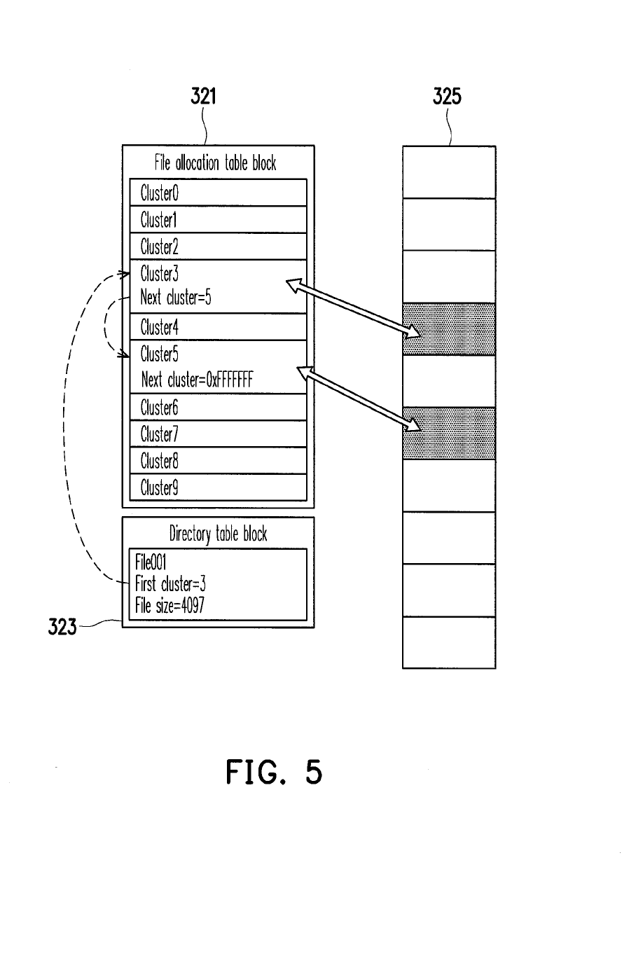

After the data is completely written, and the file is to be closed, the location information and the file information respectively stored in the location information buffer 333 and the file information buffer 335 are written into the FAT block 321 and the director table block 323. FIG. 5 is a schematic diagram illustrating a configuration of the memory card after a file closing operation is performed according to the second embodiment of the invention. Referring to FIG. 5, the first cluster in the directory table block 323 directs that an initial position that the data stored in the data block 325 is the cluster 3. Then, after the record of the cluster 3 is found from the FAT block 321, it is known that a next cluster of the cluster 3 is directed to the cluster 5, and a content of a next cluster of the cluster 5 is 0xFFFFFFF, which represents that the cluster 5 is the last cluster, i.e. an end location of data storage. In other words, the data “File001” is stored in the cluster 3 and the cluster 5. Here, two clusters are used in the FAT block 321, so that the available space of the data block 325 is reduced by two clusters.

In summary, the storage unit built in the electronic apparatus is configured with a buffer block with a suitable size to temporarily store the file information and the location information, and when the data is written, the file information and the location information originally supposed to be stored in the memory card are temporarily stored in the buffer block. After the file closing operation is performed, the file information and the location information temporarily stored in the buffer block are written to the memory card. In this way, the file information and the location information are written only when the file closing operation is performed, so that if the electronic apparatus is power-off before the file closing operation is performed, since the file information and the location information of the incomplete file are not written into the memory card, the incomplete file cannot be seen in the memory card. Moreover, since the location information is still not written into the memory card, the available space of the memory card is not reduced.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for storing data, adapted to an electronic apparatus, wherein a memory card slot of the electronic apparatus is inserted with a memory card, the method for storing data comprising:
when data is to be stored in the memory card, recording file information related to the data into a buffer block;
during a period of writing the data to the memory card, recording location information corresponding to the data stored in the memory card to the buffer block; and
writing the file information and the location information recorded in the buffer block to the memory card after a file closing operation is performed.

2. The method for storing data as claimed in claim 1, wherein the location information is file allocation table information, and the file information is directory entry information.

3. The method for storing data as claimed in claim 2, wherein the buffer block comprises a location information buffer and a file information buffer, and the method further comprises:
recording the file information of the data into the file information buffer when the data is to be stored to the memory card, and
recording the location information into the location information buffer during a process of writing the data to the memory card.

4. The method for storing data as claimed in claim 3, wherein the step of writing the file information and the location information recorded in the buffer block to the memory card when the file closing operation is performed comprises:
reading the file information from the file information buffer, and storing the file information to the memory card; and
reading the location information from the location information buffer, and storing the location information to the memory card.

5. An electronic apparatus, comprising:
a memory card slot;
a memory card, inserted into the memory card slot to store data;
a storage unit, comprising a buffer block for temporarily storing file information related to the data and location information corresponding to the data stored in the memory card; and
a processing unit, coupled to the memory card slot and the storage unit, wherein when the processing unit is about to store the data to the memory card, the processing unit records the file information to the buffer block, and during a period of writing the data to the memory card, the processing unit records the location information corresponding to the data stored in the memory card to the buffer block, and after a file closing operation is performed, the processing unit writes the file information and the location information recorded in the buffer block to the memory card.

6. The electronic apparatus as claimed in claim 5, wherein the memory card comprises:
a data block, for storing the data;
a file allocation table block, for storing the location information; and
a directory table block, for storing the file information.

7. The electronic apparatus as claimed in claim 6, wherein the buffer block comprises:
a location information buffer, for temporarily storing the location information; and
a file information buffer, for temporarily storing the file information.

8. The electronic apparatus as claimed in claim 7, wherein when the processing unit is to store the data to the memory card, the processing unit records the file information into the file information buffer, and during a process of writing the data to the memory card, the processing unit records the location information into the location information buffer.

9. The electronic apparatus as claimed in claim 7, wherein when the processing unit performs the file closing operation, the processing unit reads the file information from the file information buffer, and stores the file information to the memory card, and reads the location information from the location information buffer, and stores the location information to the memory card.

10. The electronic apparatus as claimed in claim 5, further comprising:
a photosensing device, coupled to the processing unit, for capturing the data.
